(19) United States
(12) Patent Application Publication
(10) Pub. No.: US 2013/0127170 A1
(43) Pub. Date: May 23, 2013

(54) WIND TO ELECTRIC ENERGY CONVERSION WITH HYDRAULIC STORAGE

(71) Applicant: David McConnell, Nisku (CA)

(72) Inventor: David McConnell, Nisku (CA)

(73) Assignee: Lancaster Wind Systems Inc., Nisku (CA)

(21) Appl. No.: 13/405,897

(22) Filed: Feb. 27, 2012

Related U.S. Application Data
(60) Provisional application No. 61/561,671, filed on Nov. 18, 2011.

(51) Int. Cl. F03D 9/00

(52) U.S. Cl. 290/55

(57) ABSTRACT

A system and method for converting natural resources, such as wind, to electrical energy, where the system is capable of long term energy storage in conditions of low, high or intermittent wind speeds. The system further comprises three closed-loop systems, two hydraulic closed loop systems and one gas system.

### CROSS-REFERENCE TO RELATED APPLICATIONS

This application claims priority from U.S. Provisional Application No. 61/561,671, filed Nov. 18, 2011, entitled “WIND TO ELECTRIC ENERGY CONVERSION WITH HYDRAULIC STORAGE”, the entirety of which is hereby incorporated by reference.

### TECHNICAL FIELD

An improved method and apparatus for generating electric energy from wind power is provided. More specifically, an improved method involving the combined use of hydraulic energy and long-term gas storage to provide consistent electricity from wind energy is provided.

### BACKGROUND

The use of natural and renewable resources, such as wind energy, for the production of electricity is becoming increasingly popular. With advancing technologies, new systems and methods for converting natural energy into power are being developed. Such systems are becoming increasingly capable of addressing known shortcomings of natural energy sources such as, for example, the production of small or intermittent amounts of energy due to the high variability of the resource. However, new systems that are capable of mitigating intermittent power production and providing a reliable source of power are still needed. Particularly, systems are needed that can produce excess power at times of low energy demand, and can be relied upon to produce consistent energy at times of high energy demand.

One means for mitigating variable energy production is to store energy, a process which is both difficult and expensive. Batteries, capacitors and fuel cells, for example, have limited storage capabilities and can be costly to implement. Compressed air systems may be used to store energy when electricity demand is low (e.g. during the night) and then to release the energy when demand is high (e.g. peak times during the day), however, these systems can be complex and inefficient due to high energy losses.

Other means for mitigating the variability of energy production from natural resources have attempted to increase the efficiency of energy storage systems by combining hydraulically-actuated devices with compressed air system to assist in the compression and/or expansion of gas. For instance, United States Patent Application Publication No. US 2011/0061741 A1 (the '741 patent), entitled “Compressor and/or Expander Device”, generally describes a system capable of compression/expansion of gas that includes at least one pressure vessel containing a volume of liquid or gas and an actuator coupled to and in fluid communication with the pressure vessel. As pressure increases in the pressure vessel, the volume of liquid or gas within the pressure vessel causes the movement of the actuator, thereby compressing gas to store energy. The stored energy can then be converted to electric energy for operating a motor/alternator. Such systems, however, are complex and require extremely large actuators and compressor/expanders to achieve negligible energy storage. Further, such systems require the use of extremely large storage facilities or underground caverns, which are not always practical or available.

### SUMMARY

There is a need for a system and method that is capable of storing energy for long periods of time (e.g. hours, days, weeks or months), that is not constrained by the environment (e.g. no need for large storage components, impractical underground caverns or vertical storage units), and that can generate uniform power irrespective of changing wind conditions (i.e. extremely low, high or intermittent wind speeds). Such a system may comprise a means for storing energy that is unrestricted by the location of the energy production. In other words, it would be beneficial for such a system to be capable of harvesting and storing energy, and providing the energy to any grid, regardless of the location of energy source.

There is further a need for a system and method that is capable of, where and when desired, bypassing the energy storage system and providing wind energy directly to the grid. It would be beneficial for such a system to be capable of storing energy, providing energy directly to the grid or a combination thereof.

In this regard, disclosed herein is a system capable of receiving, storing (long-term) and converting energy from a natural resource, such as wind, and providing the same to the grid, where the system may be coupled to at least one windmill or wind turbine for harvesting the wind and to at least one grid for receiving the energy. The system may include:
a. a compression assembly:
   i. coupled to receive wind energy and convert same to pressurized hydraulic fluid, and
   ii. to use pressurized hydraulic fluid to compress gas,
b. an energy storage assembly coupled to receive and store the compressed gas; and
c. a decompression assembly:
   i. coupled to receive the compressed gas and to decompress same to pressurize hydraulic fluid, and
   ii. to use pressurized hydraulic fluid to produce electric energy,
The system may form a first closed loop hydraulic system, a second closed loop gas system, and a third closed loop hydraulic system, and each closed loop system may have a high pressure side and a low pressure side.

### BRIEF DESCRIPTION OF THE DRAWINGS

FIG. 1 is a schematic illustration of an exemplary embodiment of the present system;

FIG. 2 is a cross sectional view of the wind turbine of the present system showing the blade assembly, the pump housing and the support tower;

FIG. 3 is a perspective view of the interior of the pump housing;

FIG. 4A is a schematic illustration of a plurality of compensator transformers (compression) and their connection to the high and low pressure transmission lines. Although the compensator transformers are depicted in a vertical position, it is understood that the compensator transformers may alternatively be positioned horizontally;

FIG. 4B is a schematic illustration of a plurality of compensator transformers (decompression) and their connection to the hydraulic motor/generator. Although the compensator transformers are depicted in a vertical position, it is understood that the compensator transformers may alternatively be positioned horizontally;

FIG. 5 is a schematic flowchart showing the flow of hydraulic fluid and gas in two exemplary first compensator transformers (compression);

FIG. 6 is a schematic flowchart showing the flow of hydraulic fluid and gas in two exemplary second compensator transformers (decompression), and

FIG. 7 is a schematic flowchart exemplifying the calculations shown in Example 1.

### DESCRIPTION OF EMBODIMENTS

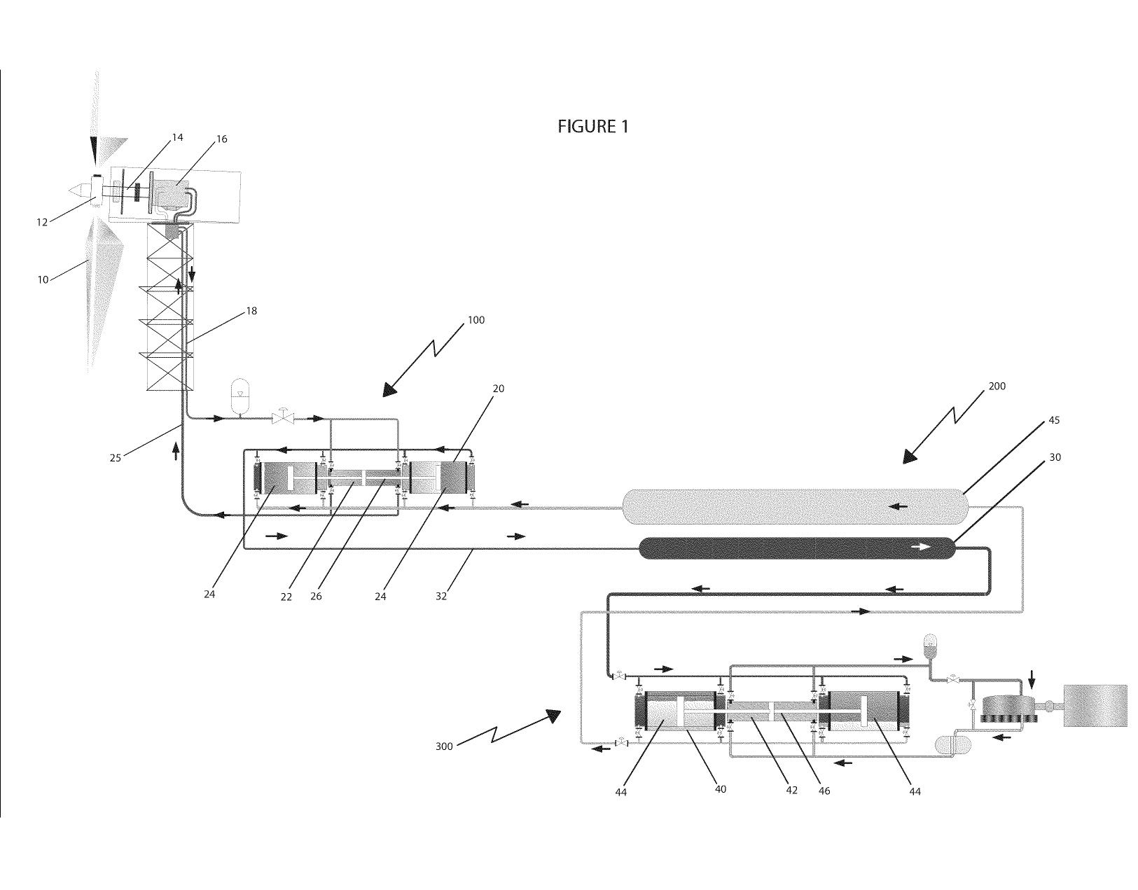

An improved system and method for receiving and storing energy harvested from a natural resource, such as wind, and for providing same to the grid, is provided. The present system will now be described having regard to FIGS. 1-7 and may include:
a) a compression assembly, coupled to at least one wind turbine system, having a first (compression) compensator transformer comprising three distinct cylinders: a hydraulic fluid cylinder “book-ended” by two gas cylinders, capable of converting wind energy to compressed gas,
b) an energy storage assembly, coupled to the compression assembly, for receiving and storing the compressed gas, and
c) a decompression assembly, coupled to the energy storage assembly, having a second (decompression) compensator transformer comprising three distinct cylinders: a hydraulic fluid cylinder “book-ended” by two gas cylinders, capable of receiving and converting compressed gas to electric energy,
   where the present system forms a first closed loop (hydraulic fluid) system, a second closed loop (gas) system, and a third closed loop (hydraulic fluid) system.

### Compression Assembly

Having regard to FIG. 1, the compression assembly, which is coupled to a wind turbine system, i.e. a windmill or wind farm having a blade assembly and a pump housing at the top of a support tower (nacelle), comprises an apparatus and method for receiving wind energy and utilizing the wind energy to pressurize hydraulic fluid.

The compression assembly 100 may be coupled to any wind turbine system (new or existing) capable of harvesting wind. Further the present compression assembly 100 may comprise a combination of both new and retrofitted wind turbine systems. By way of example, an existing wind farm system may be retrofitted with the present compression assembly 100 and the retrofitted compression assembly may: a) provide compressed gas to the same energy storage assembly or assemblies as a new wind turbine system (i.e. both old and new turbines harvest wind energy for the same energy storage assembly), b) provide compressed gas to its own distinct energy storage assembly or assemblies, or c) bypass the energy storage assembly to provide energy directly to the grid. The grid may be the same grid supplied by other retrofitted or new wind turbines.

### Wind System

Generally, the present compression assembly 100 is coupled to any common wind turbine system having a blade assembly 10 coupled at its hub 12 to a hydraulic pump driveshaft 14 for driving at least one hydraulic pump 16. It is understood that any at least one hydraulic pump 16 may be used, including an existing or commercially available pump, provided that the pump is capable of providing the desired hydraulic pressure and flow to the system. As the blade assembly 10 captures wind energy, the blades rotate about the center axis of the hub 12, resulting in rotation of the hydraulic pump driveshaft 14. Rotation of the hydraulic pump driveshaft 14 causes the at least one hydraulic pump 16 to pressurize hydraulic fluid in a high-pressure hydraulic fluid line 18. Preferably, the at least one hydraulic pump is positioned within a pump housing at the top of the support tower or nacelle.

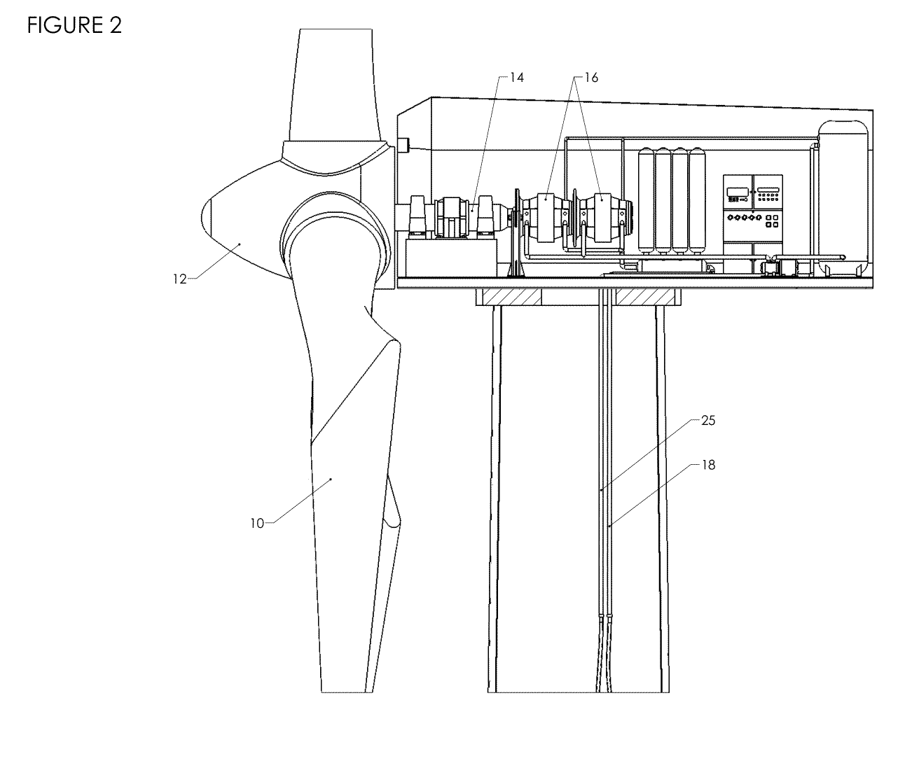

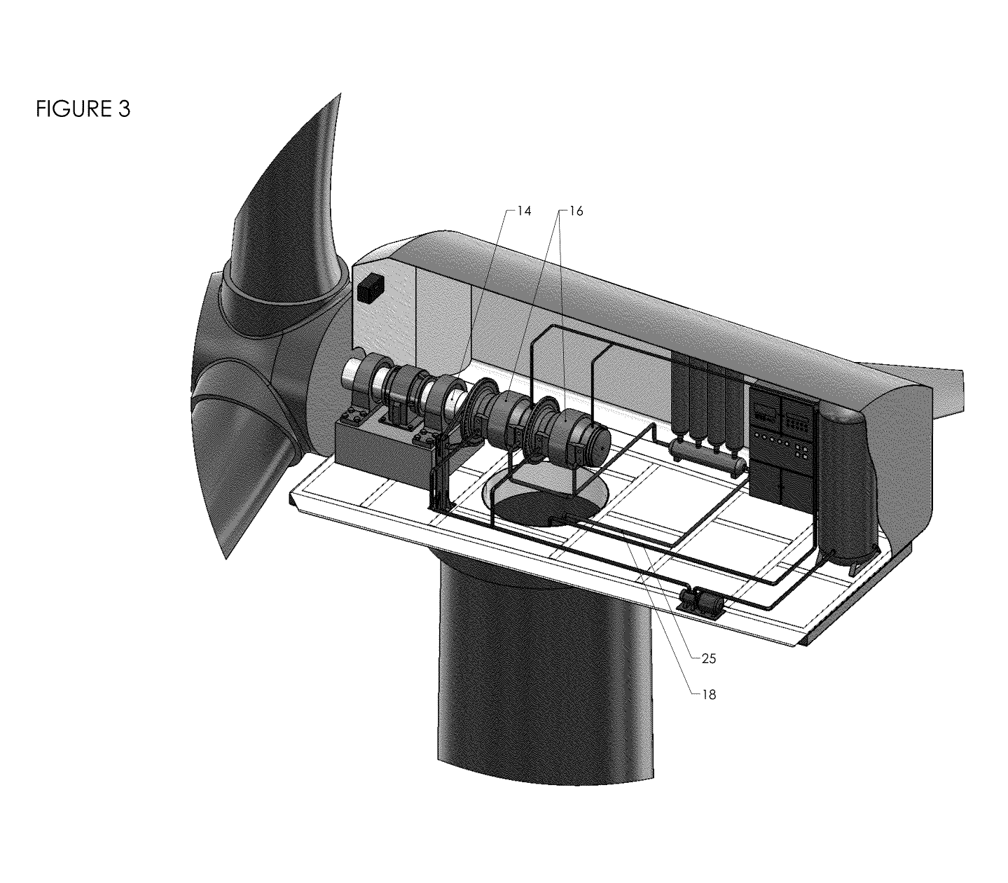

In one embodiment, the hydraulic pump driveshaft 14 may be coupled to at least two hydraulic pumps 16 (see FIGS. 2 and 3), positioned in alignment along the hydraulic pump driveshaft 14. The hydraulic pump driveshaft 14 may be supported in place within the pump housing by pillow block bearings. As a backup system and to assist in regulating the present energy storage system, it is understood that where necessary, the present wind turbine system may further comprise a hydraulic fluid reserve reservoir (e.g. ˜400 gallon reservoir), coupled to a hydraulic booster pump, for circulating hydraulic fluid back to the hydraulic pump (see FIGS. 2 and 3).

One example of a suitable wind turbine system is the commercially available Vestas V52-850 kW (Vestas Wind Systems A/S, Denmark), having the OptiTip® pitch regulation system and a capacity of 2.55 MWs. The pitch regulation system provides that the blade assembly 10 may be adjusted depending upon the wind direction and velocity, thereby enabling maximum wind band velocity. For instance, winds as low as 9 m/s may result in rotation of the present blade assembly 10 at 26 rpm. It is understood that any rotation of the blade assembly 10 the present wind turbine system can result in the production of hydraulic pressure in the high-pressure hydraulic fluid line 18.

One example of a suitable at least one hydraulic pump 16 is the commercially available light and compact Hagglund CBP-560 hydraulic pump (Hagglunds Drive AB, SE). It should be understood that any hydraulic pump capable of producing hydraulic pressure and low wind speed (rpm) may be used. The pressurized hydraulic fluid produced in the high-pressure hydraulic fluid line 18 can then be used to compress gas for storage.

### First Compensator Transformer

As discussed, the present compression assembly 100, coupled to at least one new or existing wind turbine system, receives harvested wind energy and produces high-pressure hydraulic fluid. The high-pressure hydraulic fluid is communicated to at least one first compensator transformer (compression) 20 via the high-pressure hydraulic fluid line 18. The at least one first compensator transformer(s) 20 comprises a self-contained unit capable of receiving the high-pressure hydraulic fluid and using same to compress gas. Preferably, the high-pressure fluid line 18 descends from the at least one hydraulic pump 16 positioned in the pump housing down the nacelle to the first compensator transformer(s) 20. The at least one first compensator transformer(s) 20 may be situated at ground level.

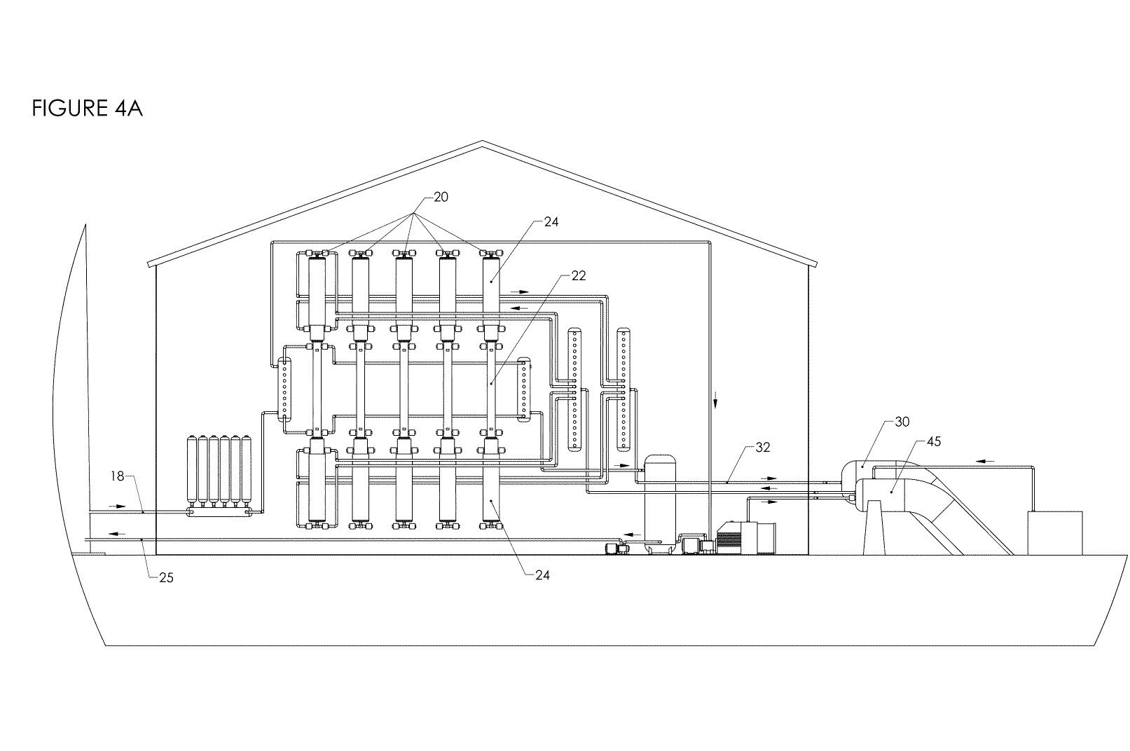

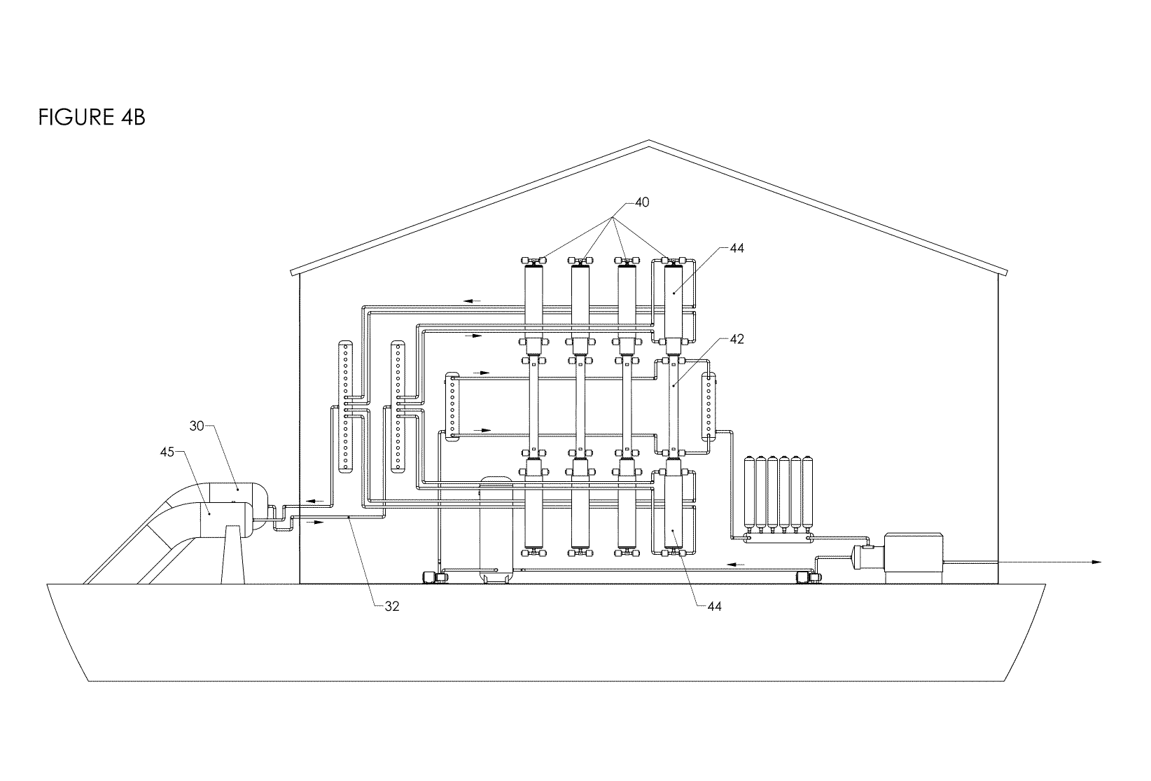

Having regard to FIG. 4A, the at least one compensator transformer(s) 20 is comprised of a central hydraulic fluid cylinder 22 “book-ended” by two distinct gas cylinders 24 (i.e. each single first compensator transformer 20 forms three distinct cylinders: one hydraulic fluid cylinder 22 and two gas cylinders 24). As a result, the hydraulic fluid and gas within the first compensator transformer do not contact each other, nor are they merely separated by a piston.

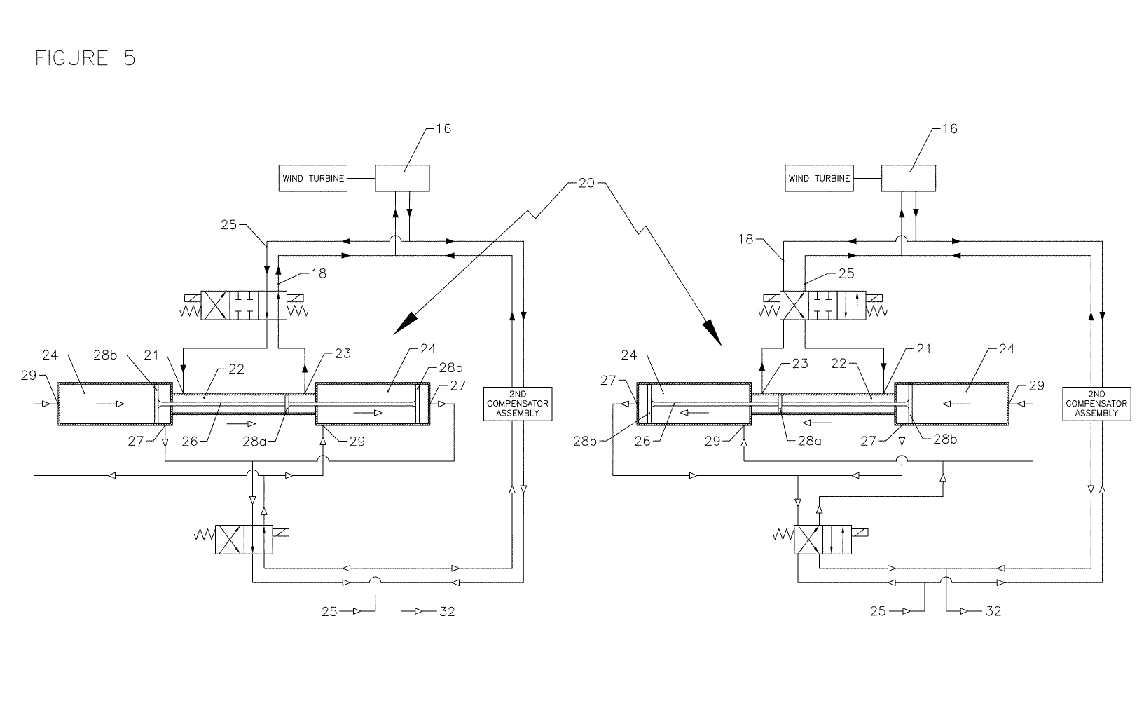

Having regard to FIG. 5, each at least one first compensator transformer(s) 20 further comprises a unitary piston shaft 26, which extends through each of the hydraulic cylinder 22 and two gas cylinders 24. The unitary piston shaft 26 supports three pistons 28: one hydraulic piston 28a positioned within the hydraulic fluid cylinder 22, and one gas piston 28b within each of the gas cylinders 24.

In operation, the high-pressure fluid is received from the high-pressure hydraulic fluid line 18, via fluid inlet ports, by the hydraulic fluid cylinder 22. As pressure increases within the hydraulic fluid cylinder 22, hydraulic piston 28a is manoeuvered and travels within the at least one compensator transformer 20. Movement of the hydraulic piston 28a (and piston shaft 26) results in simultaneous movement of both gas pistons 28b. Movement of three pistons simultaneously along a unitary piston shaft enables the present system to compound the amount of energy converted from pressurized hydraulic fluid to compressed gas (i.e. the travel of one hydraulic piston is capable of simultaneously moving two gas pistons, thereby compressing gas in two separate and distinct gas cylinders).

More specifically, the hydraulic fluid cylinder 22 receives pressurized hydraulic fluid from the high-pressure hydraulic fluid line 18 via one of two fluid inlet ports 21. For example, the hydraulic fluid enters one of said inlet ports 21 into a first side of the hydraulic fluid cylinder 22 and increases pressure within the first side of the cylinder 22. As pressure increases, the hydraulic piston 28a within the cylinder 22 travels towards a second (lower pressure side) of the cylinder 22. As a result, hydraulic fluid from the second side of the hydraulic fluid cylinder 22 exits the cylinder 22 via fluid outlet ports 23 and returns to the at least one hydraulic fluid pump 16 via a low pressure hydraulic fluid line 25. It is understood that, in combination, the foregoing hydraulic fluid system comprises a first closed-loop (hydraulic fluid) system.

Movement of the hydraulic piston 28a also results in movement of the piston shaft 26 and both gas pistons 28b, thereby compressing gas in a first high-pressure side of each distinct gas cylinder 24. Compressed gas is transmitted from the high-pressure side of each gas cylinder 24 via gas outlet ports 27 and along a high-pressure transmission line for storage. In turn, as gas is compressed within the high-pressure side of each gas cylinder 24, low pressure gas from a low-pressure transmission line enters a second low pressure side of each gas cylinder 24 via gas inlet ports 29.

As a result, the present at least one first compensator transformer(s) 20 may compress gas continuously, without interruption, via a recurring pattern (i.e. continuous and constant reversal of piston stroke) until a predetermined or desired maximum operating pressure is achieved for storage. For example, it is understood that the present system may comprise more than one first compensator transformer (compression), wherein each compensator transformer operates in sequence (e.g. a recurring and/or staggered pattern), resulting in the:
constant, continuous and uninterrupted movement of the hydraulic fluid within the at least one first compensator transformer(s), and
constant, continuous and uninterrupted compression of gas for energy storage or for delivery to the grid,

regardless of the presence or strength of wind energy.

Further, it is understood that sequenced operation of the at least one compensator transformers can result in several advantages, namely: more consistent or smoother distribution of the hydraulic fluid in the hydraulic fluid cylinder from the hydraulic pump, thereby reducing the requirement or necessity of a pulsation dampener; the ability to use smaller compensator transformer(s) (e.g. hydraulic cylinder comprising 7.35 gallons) having a smaller diameter (e.g. 10 inches) and smaller pistons, and more of them. Smaller compensator transformer(s) and pistons may reduce the impact and wear and tear on the system; and easier removal of any one first compensator transformer from the system for repair, maintenance or replacement without having to shut down the entire system.

It is further contemplated that the at least one first compensator transformer(s) may operate in a staged fashion, wherein the output of compressed gas from a staged first compensator transformer can be used as the input of gas in a subsequent staged first compensator transformer, wherein the gas is then compressed by the hydraulic fluid in the hydraulic cylinder of the subsequent staged first compensator transformer. For clarity, the output pressure (gas) of the initial at least one first compensator transformer becomes the input (gas) pressure of the subsequent at least one first compensator transformer. Such staging may be performed to improve the efficiency of the overall system by, for example, maximizing the use of hydraulic energy from the beginning of the compression (thereby reducing the overall compression time). It should be understood that the staged first compensator transformers may differ in size and diameter to further increase the overall efficiency of the system.

Preferably, the present at least one first compensator transformer(s) are automatically controlled.

### Energy Storage Assembly

Having further regard to FIG. 1, the present improved system comprises an energy storage assembly 200, coupled to the compression assembly 100 and operative to receive and store compressed gas. In one embodiment, an inert gas may be utilized. Preferably, nitrogen gas may be utilized.

It is contemplated that the present energy storage assembly 200 may be coupled to one or more new or existing wind turbine systems, regardless of the location of the wind turbine systems from each other (where applicable) or from the energy storage assembly 200. Indeed, it should be understood that the present energy storage assembly 200 may be operative to receive compressed gas from a plurality of compression assemblies 100 at any one or more locations. Such flexibility reduces the impact, if any, of low or unpredictable wind frequency (i.e. “dirty” electricity).

More specifically, and having regard to FIG. 1, the present energy storage assembly 200 comprises means for storing compressed gas. In one embodiment, said means for storing compressed gas may be manufactured from standard steel pipeline. Preferably, the means for storing compressed gas is at least one storage pipe 30 made of standard steel pipeline, such as that used in the oil and gas industry and installed above or below ground.

The at least one storage pipe 30 is connected, at a first end, to receive compressed gas from the first at least one compensator transformer(s) 20 via a high-pressure transmission line 32. The at least one storage pipe 30 is connected, at a second end, to at least one second compensator transformer(s) assembly 300 and to provide compressed gas thereto via the high-pressure transmission line 32. It is understood that both the high-pressure transmission line 32 and the at least one storage pipe 30 may be one and the same (i.e. may both comprise standard steel pipeline having the same diameter and installed above or below ground).

In operation, the at least one first compensator transformer(s) continuously compress gas until a predetermined or desired maximum storage pressure is achieved. It is understood that the capacity of the energy storage assembly 200 can vary and will depend upon the length of at least one storage pipe 30. Compressed gas may be stored within the at least one storage pipe 30 for any desired amount of time (e.g. hours, days or weeks), or until such compressed gas is utilized to produce energy for the grid. When needed, the compressed gas is withdrawn from the energy storage assembly 200 and decompressed via the decompression assembly 300.

### Decompression Assembly

The present improved apparatus and method further comprise a decompression assembly 300 coupled to the energy storage assembly 200 and operative to receive compressed gas from the at least one storage pipe 30. The decompression assembly 300 is capable of converting compressed (regulated) gas received from the energy storage assembly 200 into pressurized hydraulic fluid. The pressurized hydraulic fluid can then be used, in turn, to operate a hydraulic motor for producing electrical energy.

### Second Compensator Transformer

More specifically, and having regard to FIG. 4B, the present decompression assembly 300 comprises at least one second compensator transformer(s) 40 comprising a self-contained having a central hydraulic fluid cylinder 42 “book-ended” by two distinct gas cylinders 44 (i.e. each single decompression compensator transformer 40 forms three distinct cylinders: one hydraulic fluid cylinder 42 and two gas cylinders 44). As a result, the hydraulic fluid and gas within the decompression compensator transformer 40 do not contact each other, nor are they merely separated by a piston.

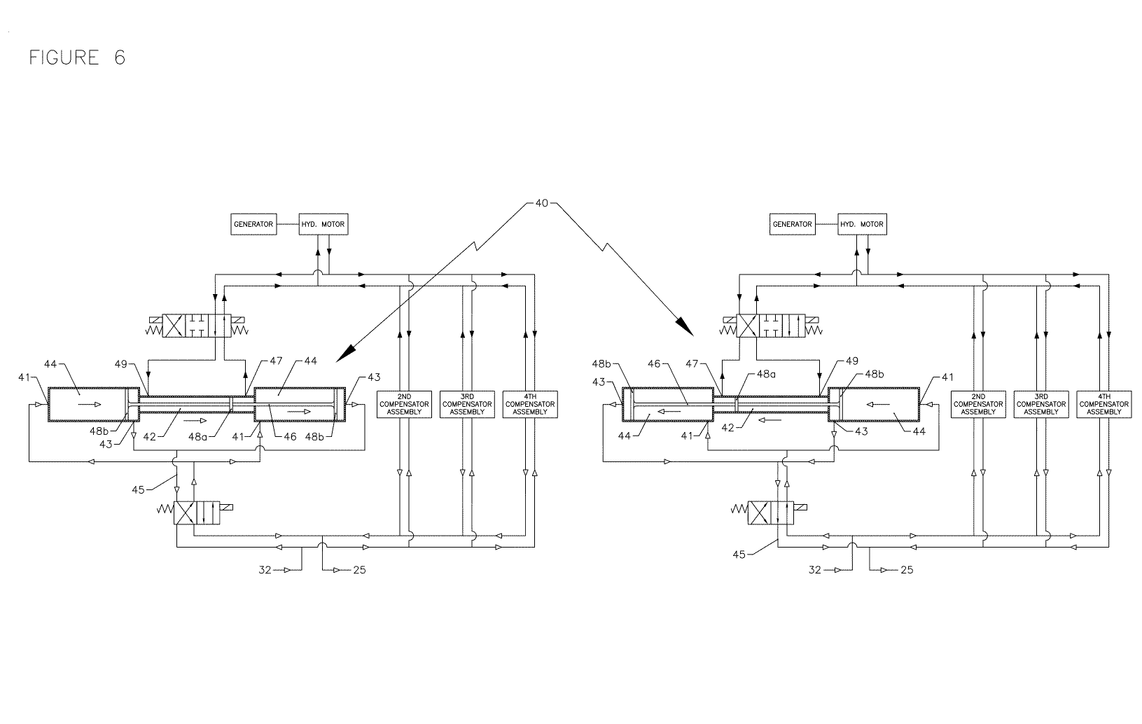

Having regard to FIG. 6, each of the at least one second compensator transformer(s) 40 further comprises a unitary piston shaft 46, which extends through each of the hydraulic cylinder 42 and two gas cylinders 44. The unitary piston shaft 46 supports three pistons 48: one hydraulic piston 48a positioned within the hydraulic cylinder 42, and one gas piston 48b positioned within each of the gas cylinders 44.

In operation, compressed gas is received from the high-pressure transmission line, via gas inlet ports 41, by the gas cylinders 44. As pressure increases within the gas cylinders 44, each of the gas pistons 48b are manoeuvered and travel within the at least one second compensator transformer 40. Movement of the gas pistons 48b (and piston shaft 46) results in simultaneous movement of the hydraulic fluid piston 48a. Movement of three pistons simultaneously along a unitary piston shaft enables the present system to compound the amount of energy converted from compressed gas to pressurized hydraulic fluid (i.e. the travel of two gas pistons are simultaneously capable of pressurizing hydraulic fluid in one hydraulic fluid cylinder).

More specifically, the gas cylinders 44 receive regulated, compressed gas from the one or two gas inlet ports 41. For example, compressed gas enters said gas ports 41 into a first side of each gas cylinder 44 and increases pressure within the first side of each cylinder 44. As pressure increases, the gas pistons 48b within the cylinder 44 travel towards a second (lower pressure side) of each cylinder 44. As a result, low pressure gas from the second side of each gas cylinder 44 exits the second compensator transformer 40 via gas outlet ports 43 and return to the energy storage assembly 200 via low pressure transmission line 45 without purging into the atmosphere. In one embodiment, the low pressure transmission line 45 may be manufactured from standard steel pipeline. Preferably, the low pressure transmission line 45 is made of standard steel pipeline, such as that used in the oil and gas industry and installed above or below ground.

As a result, the present high-pressure transmission line 32 from gas cylinders 20 of the first compensator transformer 100, the means for storing compressed gas 30, each gas cylinder 44 of the second compensator transformer 40 and the low-pressure transmission line 45 form a second closed-loop (gas) system.

Movement of the gas pistons 48b also result in movement of the piston shaft 46 and the hydraulic fluid piston 48a, thereby pressurizing fluid within the hydraulic fluid cylinder 42 of the at least one second compensator transformer 40. Pressurized fluid from the high-pressure side of the hydraulic fluid cylinder 42 exits the cylinder 42 via fluid outlet ports 47 and is converted to electrical energy for consumption. In turn, low pressure hydraulic fluid from a hydraulic motor return (via a reserve tank) may be provided to the low pressure side of the hydraulic fluid cylinder 42 via fluid inlet port 49. It is understood that, in combination, the foregoing hydraulic fluid system comprises a third closed-loop (hydraulic fluid) system.

In one embodiment, the pressurized hydraulic fluid may be used to operate a hydraulic motor coupled to an electric generator. The hydraulic motor and generator may be utilized to generate electricity, which may be provided to a known or existing energy grid for use by consumers.

The present improved system may comprise more than one second compensator transformer(s), thereby decompressing gas and producing electrical energy therefrom continuously and without interruption. For example, the present system may comprise more than one second compensator transformer (decompression), wherein each second compensator transformer operates in sequence (e.g. recurring and/or staggered pattern) resulting in the:
constant, continuous and uninterrupted decompression of gas (stored energy) within each gas cylinder 44; and
constant, continuous and uninterrupted pressurization of hydraulic fluid within the hydraulic fluid cylinder 42 of the at least one second compensator transformer(s) 40,

regardless of the presence or strength of wind energy.

Further, sequenced operation of the at least one second compensator transformers can result in several advantages, namely: more consistent or smoother flow of pressurized hydraulic fluid, thereby reducing the requirement or necessity of pulsation dampener before the hydraulic motor and generator; the ability to use smaller second compensator transformer(s) with reduced diameter and smaller pistons, and more of them. Smaller compensator transformer(s) and pistons may reduce the overall impact and wear and tear on the system; and easier removal of one compensator transformer from the system for repair, maintenance or replacement without having to shut down the system.

Preferably, the present at least one second compensator transformer(s) are automatically controlled.

In summary, and without limiting the foregoing, a skilled person would know or understand that the present system may comprise proximity switches and linear distance sensors for reversing the piston stroke of one or more of the at least one compensator transformer(s), wherein the switches or sensors may be used with automated controls and operate at a computed timing.

It is contemplated that when the price of electricity is high or at the predetermined economical timing, the present system can be used to decompress compressed gas (at a regulated pressure and flow) to pressurize hydraulic fluid and to provide electrical energy or power to the grid.

It is contemplated, having regard to Example 2 below, that the present system may be used to store gas alone, or where desired, in combination with a system capable of providing energy directly to the grid (i.e. capable of by-passing the energy storage assembly). In other words, the present system may also be capable of by-passing the energy storage assembly and providing harvested wind energy directly to the grid for consumer use.

### Example 1

### Taber Project

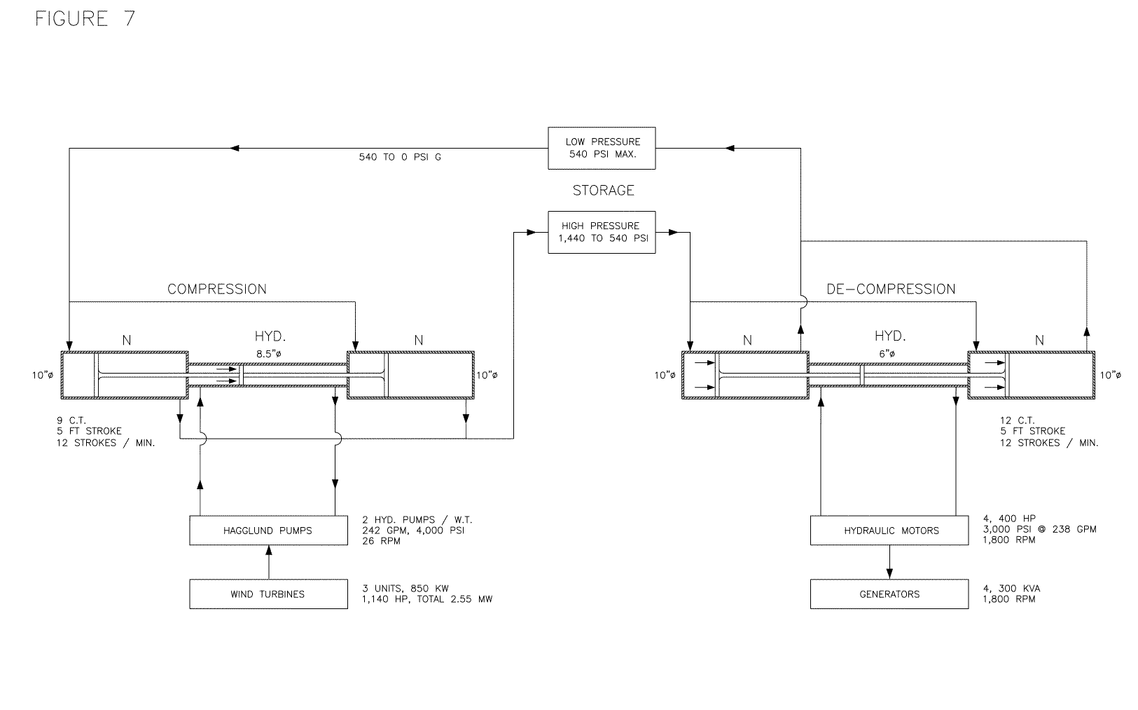

Having regard to FIG. 7, the present method and apparatus are further described by way of the following exemplary project to be located in Taber, Alberta, Canada having at least 1.2 MW for four (4) hours (4.8 MWHrs.) of energy storage capacity plus another 2.25 MW of by-pass capacity when the wind is still blowing and storage is not required. Having regard to this Example 1, the pressure and volume of compressed gas and pressurized hydraulic fluid will depend upon and will be predetermined according to the size and capacity of the generators.

### Wind Turbines:

The project uses three (3) wind turbines with a combined capacity of 2.55 MW. More specifically,

3 turbines or “units”=850 KW, 1140 HP
nominal revolution 26 rpm or 2.3 sec/rev
nominal wind speed: 9 m/s (32 KPH)
Total capacity: 2.55 MW

### Hydraulic Pumps:

Each wind turbine will have two (2) hydraulic pumps aligned on the shaft of the nacelle. More specifically,

two CBP 560 Hagglunds hydraulic pumps were used (2 units/wind turbine)
displacement: 35,200 cm³/rev. or 2,148 in³/rev
specific torque: 560 Nm/BAR or 342 in.-lbs/PSI
maximum pressure: 350 BAR or 5,075 PSI
maximum revolutions per minute=135

$$Torque \text{:} 560 Nm \text{/} BAR \times \frac{8.85 in . lb}{1 Nm} \times \frac{1 B A R}{14.5 P S I} = 341.8 \frac{in . lb}{P SI}$$

At 4,000 PSI Operating Pressure:

$$\begin{matrix}Torque = 341.8 in . lb \text{/} PSI \times 4 , 000 PSI \\ = 1 , 367 , 170 in . lb @ 4 , 000 PSI\end{matrix}$$

$$\begin{matrix}HP = \frac{torque ( in . lbs ) \times rpm}{63 , 025} \\ = \frac{1 , 367 , 170 ( in . lbs ) \times 26 rpm}{63.025} \\ = 564 HP @ 4 , 000 PSI and 26 rpm\end{matrix}$$

For 2 hydraulic pumps per wind turbine: HP (2)=1128 HP/W.T.
The wind turbine is 1140 HP. This can drive the two CBP 560 hydraulic pumps to 4,000 PSI @26 rpm (2.3 sec/rev)

$$Hydraulic Pump Flow Rate \text{:} = 35 , 200 {cm}^{3} \text{/} rev \times \frac{{in}^{3}}{16.387 {cm}^{3}} \times 26 rpm \times \frac{gal}{231 {in}^{3}} = 241.77 GPM per pump @ 26 rpm$$

$$Total Hydraulic Pump Flow Rate available \text{:} = 241.77 \times 2 \times 3 ( wind turbines ) = 1 , 450.6 gallons per minute ( for 6 hydraulic pumps )$$

### Decompression

Output of the system: 1.2 MW for 4 hours of storage
Generators: 4 units; 300 KVA
Hydraulic motors: 4 units; 400 HP @3,000 PSI
238 GPM, 500 cc/rev.
Denison gold cup, M30V

### Hydraulic Side:

### 6″ DIAMETER

$$\begin{matrix}Area = π {r}^{2} \\ = {π ( 3 )}^{2} \\ = 28.3 {in}^{2} ( rod size not considered )\end{matrix}$$

$$\begin{matrix}Volume = 28.3 {in}^{2} \times {60}^{″} stroke \\ = 1 , 700 {in}^{3}\end{matrix}$$

$$1 , 700 {in}^{3} \times \frac{1 gal}{231 {in}^{3}} = 7.35 gal$$

### N₂ Gas Side:

### 10″ DIAMETER

Area=π(5)²=78.54 in² (rod side not considered)

Volume=78.54 in²×60″ stroke=4,712 in³ or 20.4 gal or 2.73 ft³

For 2 cylinders

Volume=9,424 in³ or 40.8 gal or 5.45 ft³

### Force on Hydraulic Piston:

$$\begin{matrix}F = P \times A \\ = 3 , 000 P S I \times 28.3 {in}^{2} \\ = 84 , 900 lbs .\end{matrix}$$

The force required on the gas side to push the hydraulic piston is 84,900 lbs. Since there are 2 gas pistons, force on each gas piston is 84,900/2=42,450 lbs.

### Pressure in N₂ Gas Cylinder:

$$P = \frac{F}{A} = \frac{42 , 450}{78.54} = 540.5 P S I$$

Volume of hydraulic fluid to move in 4 hours needed for the 4 hydraulic motors

V=238 gal/min×60 min/hr×4 hrs×4 units

V_{hyd}=228,480 gal. (total hydraulic volume in 4 hours)

### Number of Compensator Transforms (CT)

Rate: 12 strokes/min or 12 in/sec, or 5 sec/stroke (60″ stroke)

$$\begin{matrix}Hydraulic flow rate per C T = 7.35 gal / stroke \times 12 stroke / min \\ = 88.2 gallons per minute\end{matrix}$$

Each hydraulic motor requires 238 gallons per minute. Number of compensator transformers per

$$hydraulic motor = \frac{238}{88.2} = 2.7$$

or 3 units for 4 hydraulic motors, total compensator transformers=3×4=12 units (w/10% allowance).
Volume of N₂ gas required to move hydraulic fluid per minute, in 12 compensator transformers at 12 strokes/min:

$$\begin{matrix}{V}_{N 2} = 40.8 \frac{gal}{stroke} \times \frac{12 strokes}{min} \times 12 C T \\ = 5 , 875 gallons per minute or 785 CFM\end{matrix}$$

Volume of N₂ gas to move that volume of fluid in 4 hrs, for 12 compensator transformers at 12 strokes/min:

$$\begin{matrix}= 5 , 875 GPM \times 60 \frac{min}{hr} \times 4 hrs \\ = 1 , 410 , 000 gal @ 540.5 P S I or 188 , 503 {ft}^{3} @ 540.5 P S I\end{matrix}$$

### Low Pressure Storage:

(gas from 12 CT in 4 hrs)
V_{LP}=1,410,000 gal or 188,503 ft³ using:

### 3-36″ Ø (35″ ID);

A=6.68 ft²×3=20.04 ft²

length of L.P. pipeline 188,500/20.04=9,406 ft or 1.78 miles (LP)

### High Pressure Storage:

### (1440 PSI)

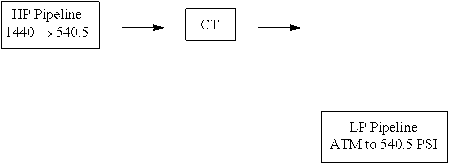

When pressure in HP pipeline drops to 540.5 PSI, it will equal pressure in LP pipeline:

Total volume of N₂ gas at 540.5 PSI
V_{T}=V_{HP}+V_{LP} (both at 540.5 PSI)
   If P₁=HP initial pressure, 1440 PSI

V₁=V_{HP} (HP pipeline volume)

P_{T}=equilibrium pressure of HP and LP=540.5 PSI

$${P}_{1} {V}_{1} = {P}_{T} {V}_{T} = {P}_{T} ( {V}_{HP} + {V}_{LP} ) = {P}_{T} {V}_{HP} + {P}_{T} {V}_{LP}$$

$$since {V}_{1} = {V}_{HP}$$

$${P}_{1} {V}_{1} = {P}_{T} {V}_{1} + {P}_{T} {V}_{LP}$$

$${V}_{1} ( {P}_{1} - {P}_{T} ) = {P}_{T} {V}_{LP} or {V}_{1} = \frac{{P}_{T} {V}_{LP}}{{P}_{1} - {P}_{T}}$$

$${V}_{1} = \frac{555.2 \times 188 , 500 {ft}^{3}}{1454.7 - 555.2} = \frac{555.2 \times 188 , 500}{899.5}$$

V_{I}=116,348 ft³ or 870,284 gal (HP storage volume)

### or V_{HP}

using 48″ Ø pipe≈47″ ID pipe

$$Area = {π ( \frac{47}{2} )}^{2} = 1 , 735 {in}^{2} or 12.048 {ft}^{2}$$

$$\begin{matrix}Length of HP pipeline = \frac{116 , 348 {ft}^{3}}{12.048 {ft}^{2}} \\ = 9 , 657 ft or 1.83 miles ( HP ) ( {48}^{″} diam . )\end{matrix}$$

### Compression

N₂ gas side: (10″ DIAMETER)

Area=π r²=π(5)²=78.54 in² (rod side not considered)

Volume=78.54 in²×60″ stroke=4,712 in² or 20.4 gal or 2.73 ft³ for 2 cylinders:

Volume=9424 in³ or 40.8 gal or 5.45 ft³

Force on the gal cylinder (1440 PSI max)

$$\begin{matrix}F = P \times A \\ = 1440 \times 78.54 \\ = 113 , 097 lbs\end{matrix}$$

For 2 gas cylinders:

F_{T}=113,097×2=226,195 lbs. This is also the force on the hydraulic cylinder.

Hydraulic pressure is 4,000 PSI

$$A = \frac{F}{P} = \frac{226 , 195}{4 , 000} = 56.55 {in}^{2}$$

$$r = \sqrt{\frac{A}{π}} = \sqrt{\frac{56.55}{π}} = 4.24 in$$

D=8.5″ Ø (rod size not considered) hydraulic cylinder diameter

$$\begin{matrix}Volume of Hydraulic Cyclinder in compensator transformer = 56.55 {in}^{2} \times 60 in stroke \\ = 3 , 393 {in}^{3} or 14.69 gal . per compensator transformer\end{matrix}$$

Hydraulic Flow Rate @12 strokes/min.

=14.69×12=176.26 GPM (hydraulic flow rate per compensator transformer)

$$\begin{matrix}No . of Compensator Transformers ( Compression ) = \frac{total avail . flow from 6 hydraulic pumps}{hydraulic flow per compensator transformer} \\ = \frac{1 , 450.6}{176.26} \\ = 8.23 or 9 units ( 9 \% allowance )\end{matrix}$$

Gas flow rate (compression side)

Volume of gas (2 cyl.)=40.8 gal or 5.45 ft³

@12 strokes/min.; 9 compensator transformers

$$\begin{matrix}Total gas flow rate = 40.8 gal / stroke \times 12 strokes / min \times 9 C . T . \\ = 4 , 406 G P M ( total gas flow rate ) or 589 CFM\end{matrix}$$

Total volume of N₂ gas needed in the system @ atmospheric pressure

Equilibrium volume @540.51 PSI of HP and LP pipelines

$$\begin{matrix}{V}_{T} = {V}_{HP} + {V}_{LP} \\ = 116 , 348 {ft}^{3} + 188 , 500 {ft}^{3} \\ = 304 , 848 {ft}^{3} @ 540.5 P S I\end{matrix}$$

$$\begin{matrix}{V}_{ATM} = \frac{{P}_{540.5} \times {V}_{T}}{{P}_{ATM}} \\ = \frac{( 540.5 + 14.7 ) \times 304 , 848 {ft}^{3}}{14.7} \\ = \frac{555.2 \times 304 , 848 {ft}^{3}}{14.7} \\ = 11 , 513 , 714 {ft}^{3} or 86.1 M gal {N}_{2} @ atmospheric pressure\end{matrix}$$

### Example 2

### Taber by-Pass Project

If storage in the high pressure pipeline is at the maximum capacity, for example the 1400 PSI as described in Example 1, and wind is still blowing, the present system and apparatus can still produce power by by-passing compensator transformers (compression/decompression) and supply hydraulic fluid directly to another set (6 units) of hydraulic motors/generators.

Total hydraulic flow rate available from 6 hydraulic pumps:

4,000 PSI; 2,148 in³/rev; 242 GPM @26 rpm

=242 GPM×6=1,452 GPM (for 6 hydraulic pumps)

Using hydraulic motor, Denison Gold Cup, M30V

Torque 487 in·lbs./100 PSI; @4,000 PSI; 228 GPM @1800 rpm

Torque—19,480 lbs·in or 1,623 ft-lbs

$$\begin{matrix}HP = \frac{19 , 480 \times 1800 rpm}{63 , 025} \\ = 556 HP or 415 KW @ 90 \% efficiency generator \\ = 375 KW\end{matrix}$$

$$\begin{matrix}No . of hyd . motors \text{:} = \frac{1 , 452 GPM ( 6 hyd . P . )}{238 GPM / unit} \\ = 6.1 or 6 units\end{matrix}$$

Total by-pass capacity=6×375 KW=2.25 MW
Maximum capacity of system:

Storage: 1.2 MW (4 hrs)

By-pass: 2.25 (2.5 max)

Total: 3.45 MW

### CONCLUSIONS

Considering all the usage and efficiency factors, this project can produce 10,500 MWHr (storage) plus 6,000 MWHr (by-pass) annually. This 16,500 MWHr annual production is equivalent to 10,700 tonnes of CO2 emissions in green house gas reduction.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

The embodiments of the invention in which an exclusive property or privilege is claimed are defined as follows:

1. A system, capable of receiving, storing and converting energy, for coupling to at least one wind turbine for harvesting wind energy and at least one grid for receiving electric energy, the wind turbine being coupled to means for converting the wind energy to pressurized hydraulic fluid, the system comprising:
a. a compression assembly operative to receive the pressurized hydraulic fluid and capable of converting same to compressed gas,
b. an energy storage assembly coupled to receive and store the compressed gas; and
c. a decompression assembly:
i. coupled to receive the compressed gas and to decompress same to pressurize hydraulic fluid, and
ii. to use pressurized hydraulic fluid to produce electric energy,
wherein the system forms a first closed loop hydraulic system, a second closed loop gas system, and a third closed loop hydraulic system, each closed loop system having a high pressure side and a low pressure side.

2. The system of claim 1, wherein the compression assembly comprises at least one first compensator transformer capable of converting pressurized hydraulic fluid into compressed gas.

3. The system of claim 2, wherein the at least one first compensator transformer comprises a distinct hydraulic cylinder and two distinct gas cylinders.

4. The system of claim 1, wherein the energy storage assembly is manufactured from standard steel pipeline.

5. The system of claim 4, wherein the energy storage assembly may be positioned above or below ground.

6. The system of claim 1, wherein the decompression assembly comprises at least one second compensator transformer capable of converting compressed gas to pressurized hydraulic fluid.

7. The system of claim 6, wherein the at least one second compensator transformer comprises a distinct hydraulic cylinder and two distinct gas cylinders.

8. The system of claim 1, wherein the gas is an inert gas.

9. The system of claim 8, wherein the inert gas is nitrogen gas.
